(19) United States
(12) Patent Application Publication
(10) Pub. No.: US 2026/0084593 A1
(43) Pub. Date: Mar. 26, 2026

(54) FIXING COMPONENT, MOUNTING COMPONENT, AND BABY PRODUCT

(71) Applicant: WONDERLAND SWITZERLAND AG, Steinhausen (CH)

(72) Inventors: Bo WU, Dongguan (CN); Ziqiang HE, Dongguan (CN); Meifeng FAN, Dongguan (CN); Xiuming WU, Dongguan (CN); Wenhao LI, Dongguan (CN)

(21) Appl. No.: 19/121,286

(22) PCT Filed: Oct. 17, 2023
(86) PCT No.: PCT/EP2023/078780

§ 371 Date: Apr. 15, 2025

(30) Foreign Application Priority Data
Oct. 17, 2022 (CN) 202211267614.7

(51) Int. Cl. B60N 2/28; A44B 17/00; A44B 18/00; B60N 2/58

(52) U.S. Cl. CPC B60N 2/2806; A44B 17/0005; A44B 18/0073; B60N 2/5875

(57) ABSTRACT

The present application discloses a fixing component, a mounting component, and a baby product. The fixing component includes a connecting member, an adhesive medium, and a flexible structure. The adhesive medium is disposed between the connecting member and the flexible structure; and the connecting member is fixed to the flexible structure via the adhesive medium.

### CROSS REFERENCE TO RELATED APPLICATION

This application is a U.S. National Phase Application of International Application No. PCT/EP2023/078780, filed on Oct. 17, 2023, and claims priority to Chinese patent application No. 202211267614.7, filed on Oct. 17, 2022, the entire content of which is incorporated herein by reference in its entirety.

### TECHNICAL FIELD

The present application relates to the technical field of baby products, in particular to a fixing component, a mounting component, and a baby product.

### BACKGROUND

Baby products, such as strollers, child safety seats or crib mattresses, are usually provided with flexible structures such as knitted fabrics to improve the comfort for the baby. For various functional needs, the flexible structures are usually provided with connecting members such as hook and loop fasteners or snap buttons, to connect different flexible structures or different portions of the same flexible structure. The connecting members and the flexible structures are generally fixed by sewing. On the one hand, a manner of sewing requires more manpower and is unaesthetic, on the other hand, the connection strength between the connecting members and the flexible structure is poor, connection failures are easy to occur after long-term use. In addition, frequent sewing will also result in many small holes on the flexible structure, thereby causing damage to the flexible structure. In addition, after the connecting member is inserted and fixed into the flexible structure, the flexible structure will also be damaged after repeated use operations.

### SUMMARY

Accordingly, it is necessary to provide a fixing component, a mounting component, and a baby product. Strong and reliable connections may be formed between connecting members and flexible structures of the fixing component, the mounting component, and the baby product.

A fixing component applied to a baby product includes a connecting member, an adhesive medium, and a flexible structure. The adhesive medium is provided between the connecting member and the flexible structure. The connecting member is fixed to the flexible structure via the adhesive medium.

The connecting member is fixed on the flexible structure through the adhesive medium, so that the connecting member is firmly bonded to the flexible structure, and it is difficult to cause the connection failure. In addition, compared with the conventional sewing fixing manners, the fixing through the adhesive medium can greatly save manpower and cost, and will not leave sewing marks or form more holes on the flexible structure, and can hardly affect the overall appearance of the baby product.

In an embodiment, the connecting member is fixed to the flexible structure by hot pressing.

In an embodiment, the adhesive medium is a polyurethane adhesive.

In an embodiment, the connecting member is a hook surface or a loop surface of a hook and loop fastener.

In an embodiment, the flexible structure is made of fabric.

In an embodiment, the flexible structure is made of polyester or knitted fabric.

In an embodiment, the fixing component further includes a reinforcing structure. The reinforcing structure is fixed to the flexible structure via the adhesive medium, and positioned between the connecting member and the flexible structure. The connecting member extends through and is fixed to the reinforcing structure and the flexible structure.

A baby product includes a body and a fixing component including a first connecting member, a first adhesive medium, and a flexible structure. The flexible structure is at least partially disposed on the body. The first adhesive medium is provided between the first connecting member and the flexible structure. The first connecting member is fixed to the flexible structure via the first adhesive medium.

In an embodiment, the first connecting member is fixed to the flexible structure by hot pressing.

In an embodiment, the fixing component further includes a second connecting member having an end connected to the first connecting member.

In an embodiment, the fixing component further includes a second connecting member and a second adhesive medium. The second connecting member is fixed to the flexible structure via the second adhesive medium.

In an embodiment, the first connecting member is a hook surface of a hook and loop fastener, and the second connecting member is a loop surface of a hook and loop fastener.

A fixing component applied to a baby product, includes a connecting member, an adhesive medium, a reinforcing structure, and a flexible structure. The adhesive medium is provided between the reinforcing structure and the flexible structure. The reinforcing structure is fixed to the flexible structure via the adhesive medium. The reinforcing structure covers at least a part of a surface of the flexible structure. The connecting member extends through and is fixed to the reinforcing structure and the flexible structure.

In an embodiment, the reinforcing structure is fixed to the flexible structure via the adhesive medium through hot pressing.

In an embodiment, the adhesive medium is a polyurethane adhesive.

In an embodiment, the connecting member includes a connecting portion and a fixing portion. The connecting portion and the fixing portion are respectively positioned on both sides of the flexible structure. The fixing portion is configured to extend through the reinforcing structure and the flexible structure to be connected to the connecting portion. Or, the connecting portion is configured to extend through the reinforcing structure and the flexible structure to be connected to the fixing portion.

In an embodiment, the fixing portion includes a spiked portion, the connecting portion is provided with a matching hole. The spiked portion extends through the reinforcing structure and the flexible structure to be detachably engaged with the matching hole.

In an embodiment, the connecting portion is a male snap button or a female snap button.

In an embodiment, the reinforcing structure and the flexible structure are both made of fabric, and an elasticity of the reinforcing structure is lower than an elasticity of the flexible structure.

In an embodiment, the reinforcing structure is made of a polyester; and the flexible structure is made of elastic knitted fabric.

In an embodiment, a cushioning structure is provided between the reinforcing structure and the flexible structure.

A fixing component applied to a baby product, includes a first connecting member, a second connecting member, a first adhesive medium, a second adhesive medium, a first reinforcing structure, a second reinforcing structure, and a flexible structure. The first reinforcing structure is fixed to the flexible structure via the first adhesive medium, the second reinforcing structure is fixed to the flexible structure via the second adhesive medium. The first connecting member extends through and is fixed to the first reinforcing structure and the flexible structure, and the second connecting member extends through and is fixed to the second reinforcing structure and the flexible structure.

In an embodiment, the first reinforcing structure is fixed to the flexible structure via the first adhesive medium through hot pressing; and the second reinforcing structure is fixed to the flexible structure via the second adhesive medium through hot pressing.

In an embodiment, the first connecting member and the second connecting member are snap button components.

In an embodiment, the first connecting portion is a male snap button; and the second connecting portion is a female snap button.

A baby product includes a body and the fixing component according to any one of the aforementioned embodiments. The flexible structure is at least partially fixed to the body.

A mounting component applied to a baby product, includes a reinforcing member, a third adhesive medium, and a flexible structure provided with a first through hole. The reinforcing member includes a second through hole corresponding to the first through hole. The reinforcing member is fixed to the flexible structure via the third adhesive medium. The first through hole and the second through hole are at least partially overlapped with each other.

In an embodiment, the reinforcing member is fixed to the flexible structure via the third adhesive medium through hot pressing.

In an embodiment, the flexible structure is provided with a plurality of first through holes, and a plurality of reinforcing member are provided correspondingly. The plurality of second through holes of the plurality of reinforcing member are at least partially overlapped with the plurality of first through holes respectively.

In an embodiment, the flexible structure is made of polyester or mesh cloth; and the reinforcing member is made of rubber.

A baby product includes a structural frame, a belt-shaped structure, and the mounting component according to any one of the aforementioned embodiments. The flexible structure is at least partially fixed to the structural frame, and the belt-shaped structure extends through the first through hole and the second through hole.

In an embodiment, the baby product is a vehicle safety seat or a stroller. The flexible structure is a backrest seat cloth or a base seat cloth. The belt-shaped structure is a safety belt.

These and other objects, advantages, purposes and features will become apparent upon review of the following specification in conjunction with the drawings.

### BRIEF DESCRIPTION OF THE DRAWINGS

To illustrate the technical solutions according to the embodiments of the present invention or in the prior art more clearly, the accompanying drawings for describing the embodiments or the prior art are introduced briefly in the following. Apparently, the accompanying drawings in the following description are only some embodiments of the present invention, and persons of ordinary skill in the art can derive other drawings from the accompanying drawings without creative efforts.

FIG. 1 is a front view of a fixing component according to an embodiment of the present application.

FIG. 2 is a rear view of the fixing component shown in FIG. 1 (in which dotted boxes indicate that a first connecting member, a second connecting member, a first adhesive medium, and a second adhesive medium are not visible in the rear view).

FIG. 3 is a front view of a fixing component according to another embodiment of the present application (in which dotted boxes indicate that a first adhesive medium, and a second adhesive medium are not visible in the front view).

FIG. 4 is a rear view of the fixing component shown in FIG. 3, with both a first reinforcing structure and a second reinforcing structure partially covering a flexible structure.

FIG. 5 is another rear view of the fixing component shown in FIG. 3, with both the first reinforcing structure and the second reinforcing structure entirely covering the flexible structure.

FIG. 6 is a perspective schematic view of a first connecting portion of the fixing component shown in FIG. 3.

FIG. 7 is a perspective schematic view of a first fixing portion of the fixing component shown in FIG. 4.

FIG. 8 is a perspective schematic view of a second connecting part of the fixing component shown in FIG. 3.

FIG. 9 is a perspective schematic view of a second fixing portion of the fixing component shown in FIG. 4.

FIG. 10 is a cross-sectional schematic view of a fixing component according to another embodiment of the present application.

FIG. 11 is a cross-sectional schematic view of a fixing component according to another embodiment of the present application.

FIG. 12 is a perspective schematic view of a baby product according to an embodiment of the present application.

FIG. 13 is an enlarged view of a portion A of FIG. 12.

FIG. 14 is a perspective schematic view of a baby product according to another embodiment of the present application.

FIG. 15 is a perspective schematic view of a baby product according to yet another embodiment of the present application.

Illustration for reference numerals:

100, structural frame; 110, backrest; 120, base; 200, fixing component; 210, flexible structure; L1, first adhesive medium; L2, second adhesive medium; 220, first connecting member; 221, first connecting portion; 2211, first matching hole; 2212, convex portion; 222, first fixing portion; 2221, first spiked portion; 230, second connecting member; 231, second connecting portion; 2311, second matching hole; 2312, concave portion; 232, second fixing portion; 2321, second spiked portion; 240, first reinforcing structure; 250, second reinforcing structure; 260, third reinforcing structure; 300, mounting component; 310, flexible structure; 311, first seat cloth; 312, second seat cloth; 320, reinforcing member; 321, second through hole; 400, belt-shaped structure; 410, first safety belt; 420, second safety belt; 430, third safety belt; 500, connecting buckle; h1, first through hole; L, adhesive medium.

### DETAILED DESCRIPTION OF THE EMBODIMENTS

In order to make the object, technical solution, and advantages of the present application clearer, the present application will be further described in detail below in conjunction with the accompanying drawings and specific embodiments. It should be understood that the specific embodiments described herein are only used to illustrate the present application, and do not limit the protection scope of the present application.

It should be noted that when a component is referred as to be “fixed to” another component, it may be directly on the other component or there may also be an intermediate component. When a component is referred as to be “connected to” to another component, it may be directly connected to the other component or there may be an intermediate component at the same time. The terms “vertical,” “horizontal,” “left,” “right,” and similar expressions are used herein for purposes of illustration only and are not intended to represent the only embodiments.

Unless otherwise defined, all technical and scientific terms used herein have the same meaning as commonly understood by one of ordinary skill in the technical field to which the present application belongs. The terms used herein in the description of the present application is only for the purpose of describing specific embodiments, and is not intended to limit the present application. As used herein, the term “and/or” includes any and all combinations of one or more of the associated listed items.

An embodiment of the present application provides a fixing component applied to a baby product such as a car safety seat, a stroller, a mattress, a baby sling, a baby carry cot, or a baby box. There is a strong and reliable connection between a connecting member and a flexible structure of the fixing component applied to the baby product.

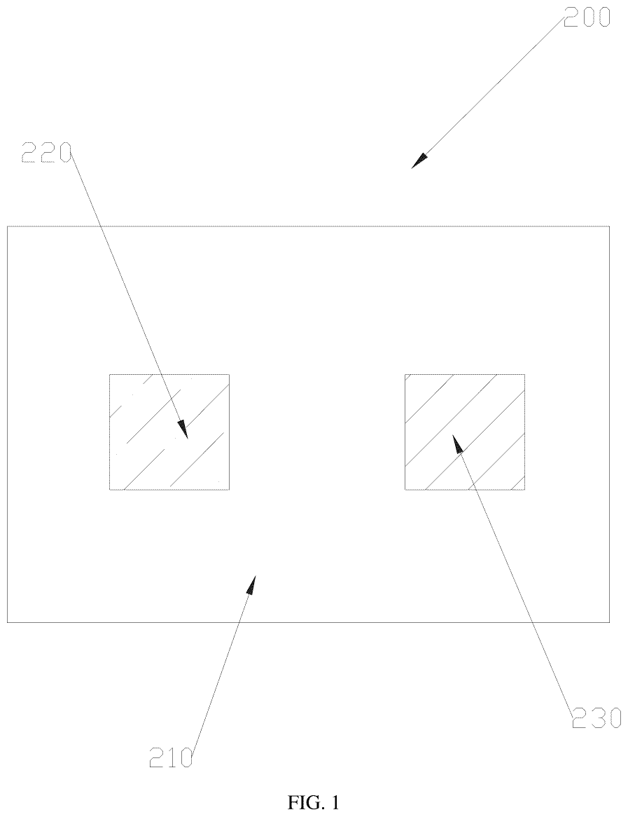

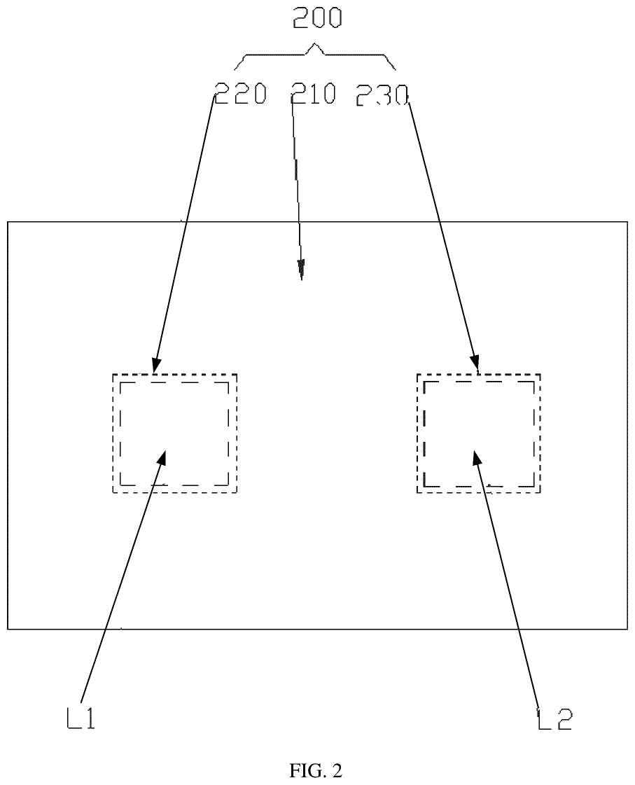

As shown in FIGS. 1 and 2, a fixing component 200 is at least partially applied on a body of the baby product. Further, the fixing component 200 may be implemented in various ways.

In an embodiment, as shown in FIGS. 1 and 2, the fixing component 200 includes a flexible structure 210, at least one connecting member, and an adhesive medium.

The flexible structure 210 may be made of a single-layer fabric or a multi-layer fabric. For example, the fabric may be an awning cloth or seat cloth covering a frame, or a seat cloth covering a backrest or a base of a vehicle safety seat. In another embodiment, the fabric may be webbing. The flexible structure 210 may be made of, for example, polyester, acrylic, nylon, or knitted fabric. The flexible structure 210 may be made of a piece of fabric, or may include multiple pieces of fabric. In this embodiment, the flexible structure 210 is made of a piece of fabric.

In this embodiment, the fixing component 200 includes a first connecting member 220 and a second connecting member 230. In addition, as shown in FIG. 2, the fixing component 200 according to this embodiment is provided with a first adhesive medium L1 and a second adhesive medium L2 corresponding to the first connecting member 220 and the second connecting member 230, respectively. It should be noted that, the number of connecting members is not necessary to be limited to be the same as the number of adhesive media in present application. Furthermore, the number of connecting members can also be greater or less than the number of adhesive media.

The first connecting member 220 is detachably connected to the second connecting member 230. In this embodiment, the first connecting member 220 is a hook surface of a hook and loop fastener, and the second connecting member 230 is a loop surface of the hook and loop fastener. In other embodiments, the first connecting member 220 and the second connecting member 230 may also be other structures capable of being detachably connected to each other. The first connecting member 220 and the second connecting member 230 may be arranged on different portions of the same piece of fabric, or may be arranged on different fabrics. For example, when the flexible structure 210 is configured to cover the frame of a stroller, the flexible structure 210 may include an awning cloth and a backrest seat cloth of the stroller. The first connecting member 220 may be arranged on the awning cloth, and the second connecting member 230 may be arranged on the backrest seat cloth. In this way, the detachable connection between the awning cloth and the backrest seat cloth may be implemented through the first connecting member 220 and the second connecting member 230. In other embodiments, the application of the fixing component 200 of the present disclosure is not limited thereto.

As shown in FIG. 2, the first adhesive medium L1 is disposed between the first connecting member 220, and the flexible structure 210, and the first connecting member 220 is fixed to the flexible structure 210 via the first adhesive medium L1. The second adhesive medium L2 is disposed between the second connecting member 230 and the flexible structure 210, and the second connecting member 230 is fixed to the flexible structure 210 via the second adhesive medium L2.

In this embodiment, both the first adhesive medium L1 and the second adhesive medium L2 are polyurethane adhesives. In other embodiments, the first adhesive medium L1 and the second adhesive medium L2 may also be other types of adhesives such as polyamide, polyester, or polyethylene. The first adhesive medium L1 (or the second adhesive medium L2) is selected generally by comprehensively considering the materials used to make the first connecting member 220 (or the second connecting member 230) and the flexible structure 210 to be connected. The first adhesive medium L1 (or the second adhesive medium L2) is required to have relatively similar properties to the first connecting member 220 (or the second connecting member 230) and the flexible structure 210 to be connected respectively.

Further, the fixing component 200 may also be subjected to hot pressing, so that under high temperature and high pressure, the first adhesive medium L1 can fix the first connecting member 220 and the flexible structure 210 to each other more tightly, and the second adhesive medium L2 can fix the second connecting member 230 and the flexible structure 210 to each other more tightly. In an embodiment, the hot pressing may be performed using a thermal transfer device.

The first connecting member 220, the first adhesive medium L1, and the flexible structure 210 are taken as an example to illustrate the specific process of the hot pressing.

The flexible structure 210 is placed on a working platform. Then, the first connecting member 220 (which is the hook surface of the hook and loop fastener in this embodiment) is laid flat on the flexible structure 210. The first adhesive medium L1 is disposed on a surface of the flexible structure 210 facing the first connecting member 220 or a surface of the first connecting member 220 facing the flexible structure 210. Then, the thermal transfer device is moved above the first connecting member 220 to press the first connecting member 220 and the flexible structure 210 such that the first connecting member 220 is bonded to the flexible structure 210.

Hot pressing processes of the second connecting member 230, the second adhesive medium L2, and the flexible structure 210 are similar to the above, and which will not be repeated herein. In other embodiments, a pressure and a temperature of the hot pressing can also be adjusted as required.

In other embodiments, the second connecting member 230 and the second adhesive medium L2 of the fixing component 200 can also be omitted. The first connecting member 220 may be connected to corresponding connecting structures of other external devices. For example, in this embodiment, the first connecting member 220 is a hook surface of the hook and loop fastener, which may be used to be connected to a loop surface of the hook and loop fastener on a backpack of a caregiver, so that the caregiver can fix the backpack on the baby product to reduce the load on the caregiver.

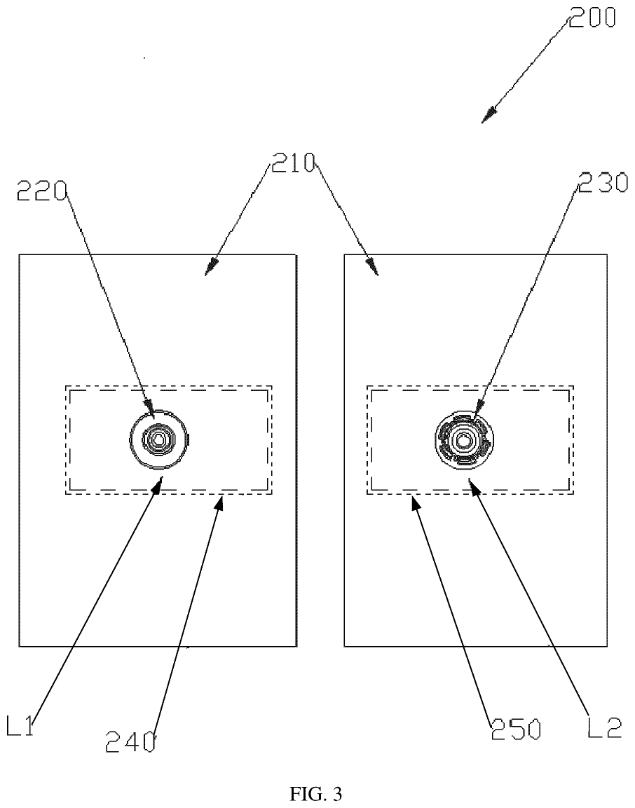

In another embodiment, as shown in FIGS. 3 to 5, the fixing component 200 may also include a flexible structure 210, a first connecting member 220, a second connecting member 230, a first adhesive medium L1 (not shown), a second adhesive medium L2 (not shown), a first reinforcing structure 240, and a second reinforcing structure 250.

As mentioned above, the flexible structure 210 may be a fabric covering the frame or the vehicle safety seat. For example, the flexible structure 210 may be an awning cloth or a seat cloth covering the frame, or a seat cloth covering an outside of the backrest or the base of the vehicle safety seat. The flexible structure 210 may be made of, for example, polyester, acrylic, nylon, knitted fabric, or thick dyed fabric of 300D or above. The flexible structure 210 may be made of a piece of fabric, or may include multiple pieces of fabric. In this embodiment, the flexible structure 210 is two pieces of fabric separated from each other.

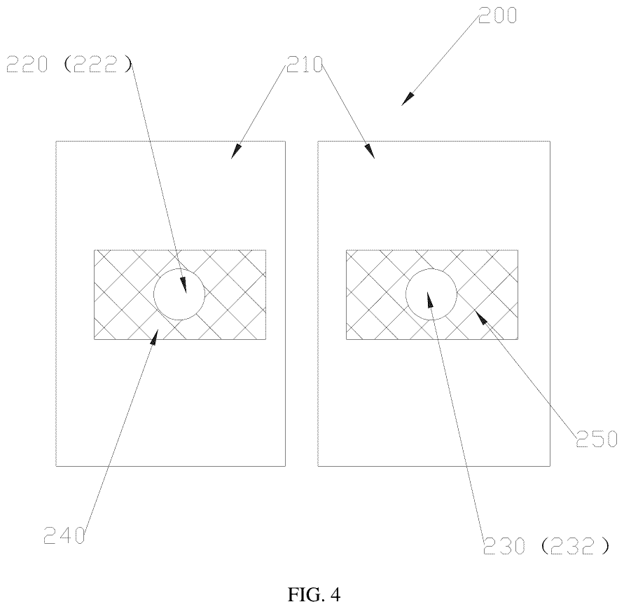

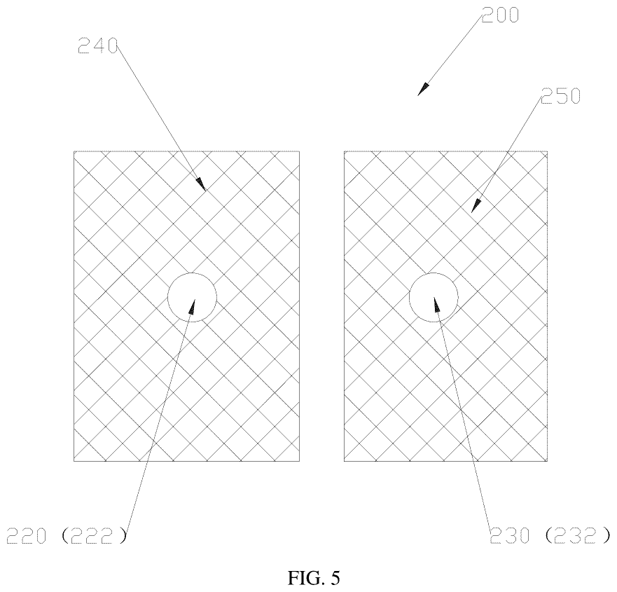

As shown in FIG. 4, the first reinforcing structure 240 (or the second reinforcing structure 250) covers part of a surface of the flexible structure 210, but which is not limited thereto. As shown in FIG. 5, in another embodiment, the first reinforcing structure 240 (or the second reinforcing structure 250) covers the entire surface of the flexible structure 210. In an embodiment, the elasticity of the first reinforcing structure 240 and the second reinforcing structure 250 is lower than that of the flexible structure 210. In other words, the first reinforcing structure 240 and the second reinforcing structure 250 may be made of fabrics with low elasticity, such as polyester, or non-elastic knitted fabric.

When the flexible structure 210 is made of a material with relatively high elasticity, such as knitted fabric or thick dyed fabric of 300D or above, gaps between yarns of the flexible structure 210 are relatively large. By disposing the first reinforcing structure 240 (or the second reinforcing structure 250) with low elasticity between the first connecting member 220 (or the second connecting member 230) and the flexible structure 210, the connection strength between the first connecting member 220 (or the second connecting member 230) and the flexible structure 210 can be enhanced.

Foam (not shown) may also be provided or filled between the first reinforcing structure 240 and the flexible structure 210 to provide cushioning. In other embodiments, other types of cushioning structures such as silicone or rubber may also be provided between the first reinforcing structure 240 and the flexible structure 210. Alternatively, in other embodiments, the cushioning structure may not be disposed. Similarly, the second reinforcing structure 250 also covers part or all of the surface of the flexible structure 210. The second reinforcing structure 250 is made of non-elastic fabric, such as polyester, or non-elastic knitted fabric. Foam may also be provided or filled between the second reinforcing structure 250 and the flexible structure 210 to provide cushioning. In other embodiments, other types of cushioning structures such as silicone or rubber may also be provided between the second reinforcing structure 250 and the flexible structure 210. Alternatively, in other embodiments, the cushioning structure may not be disposed.

Further, the first adhesive medium L1 is disposed between the first reinforcing structure 240 and the flexible structure 210, and the first reinforcing structure 240 is fixed to the flexible structure 210 via the first adhesive medium L1. The second adhesive medium L2 is disposed between the second reinforcing structure 250 and the flexible structure 210, and the second reinforcing structure 250 is fixed to the flexible structure 210 via the second adhesive medium L2.

In this embodiment, both the first adhesive medium L1 and the second adhesive medium L2 are polyurethane adhesives. In other embodiments, the first adhesive medium L1 and the second adhesive medium L2 may also be other types of adhesives such as polyamide, polyester, or polyethylene. The first adhesive medium L1 (or the second adhesive medium L2) is selected generally by comprehensively considering the materials used to made the first reinforcing structure 240 (or second reinforcing structure 250) and the flexible structure 210 to be connected. The flexible structure 210 is required to have relatively similar properties to the first reinforcing structure 240 (or second reinforcing structure 250) and the flexible structure 210 to be connected.

In an embodiment, the first reinforcing structure 240 (or the second reinforcing structure 250) and the flexible structure 210 may be bonded together by hot pressing. The aforementioned hot pressing may be performed using a thermal transfer device. The first reinforcing structure 240, the first adhesive medium L1, and the flexible structure 210 are taken as an example to illustrate the specific process of the hot pressing.

The flexible structure 210 is placed on a working platform. Then, the first reinforcing structure 240 (which is polyester in this embodiment) is laid flat on the flexible structure 210. The first adhesive medium L1 is disposed on a surface of the flexible structure 210 facing the first reinforcing structure 240 or a surface of the first reinforcing structure 240 facing the flexible structure 210. Then, the thermal transfer device is moved above the first reinforcing structure 240 to press the first reinforcing structure 240 and the flexible structure 210, such that the first reinforcing structure 240 is bonded to the flexible structure 210.

Hot pressing processes of the second reinforcing structure 250, the second adhesive medium L2, and the flexible structure 210 is similar to the above, and which will not be repeated herein. In other embodiments, a pressure and a temperature of the hot pressing can also be adjusted as required.

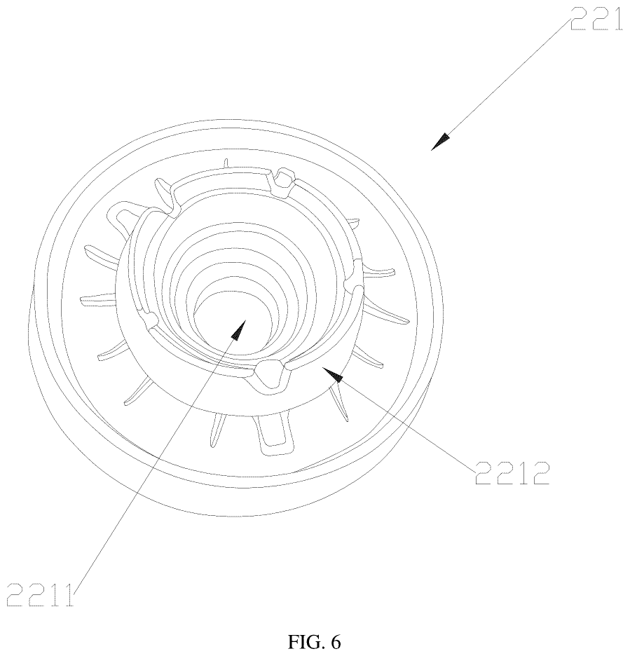

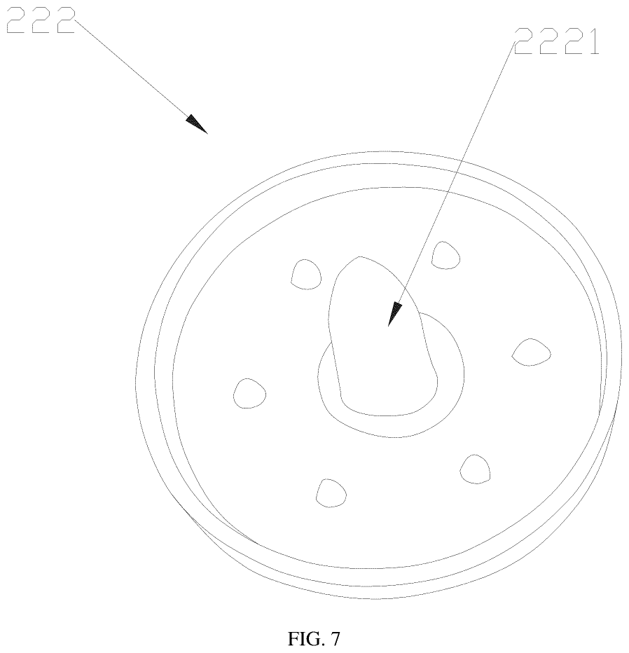

Referring to FIGS. 6 and 7, in an embodiment, the first connecting member 220 and the second connecting member 230 may be snap button components. The first connecting member 220 may include a first connecting portion 221 and a first fixing portion 222. The first connecting portion 221 and the first fixing portion 222 are positioned on both sides of the flexible structure 210, respectively. Referring to FIG. 4, the first reinforcing structure 240 is positioned between the flexible structure 210 and the first fixing portion 222.

The first fixing portion 222 is configured to extend through the first reinforcing structure 240 and the flexible structure 210 to be connected to the first connecting portion 221. In another embodiment, the first connecting portion 221 is configured to extend through the first reinforcing structure 240 and the flexible structure 210 to be connected to the first fixing portion 222. For example, in this embodiment, the first connecting portion 221 is a male snap button, and the first fixing portion 222 is a first face button. The male snap button includes a first matching hole 2211, and the first face button includes a first spiked portion 2221 that can be engaged with the first matching hole 2211. The first spiked portion 2221 extends through the first reinforcing structure 240 and the flexible structure 210 to be connected to the first matching hole 2211, so that the first connecting member 220 extends through and is fixed on the first reinforcing structure 240 and the flexible structure 210.

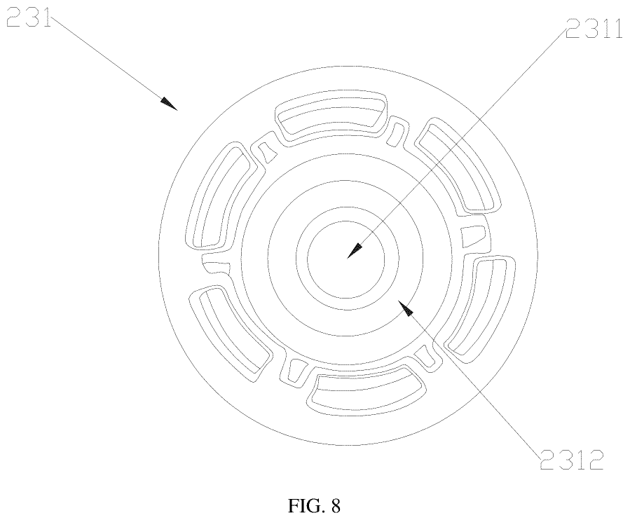

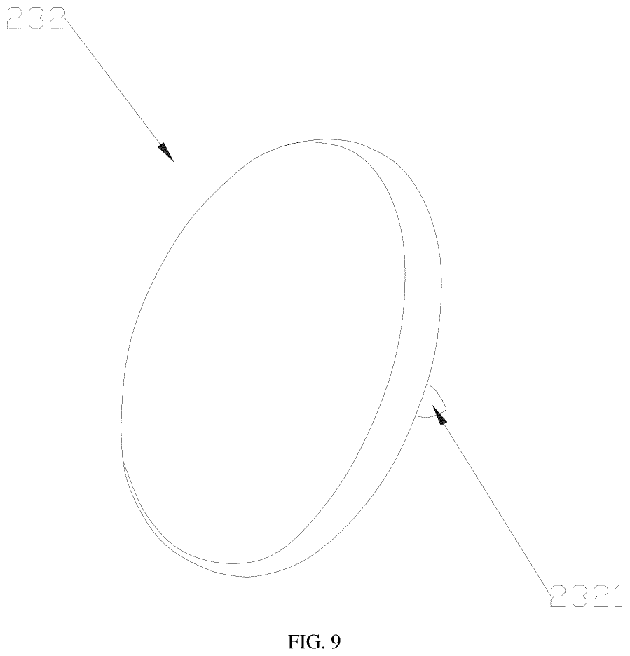

Further, as shown in FIGS. 8 and 9, the second connecting member 230 includes a second connecting portion 231 and a second fixing portion 232. The second connecting portion 231 and the second fixing portion 232 are positioned on both sides of the flexible structure 210, respectively. Referring to FIG. 4 or 5 again, the second reinforcing structure 250 is positioned between the flexible structure 210 and the second fixing portion 232. The second fixing portion 232 is configured to extend through the second reinforcing structure 250 and the flexible structure 210 to be connected to the second connecting portion 231. In another embodiment, the second connecting portion 231 is configured to extend through the second reinforcing structure 250 and the flexible structure 210 to be connected to the second fixing portion 232. For example, in this embodiment, the second connecting portion 231 is a female snap button, and the second fixing portion 232 is a second face button. The female snap button includes a second matching hole 2311, and the second face button includes a second spiked portion 2321 that can be engaged with the second matching hole 2311. The second spiked portion 2321 extends through the second reinforcing structure 250 and the flexible structure 210 to be connected to the second matching hole 2311, so that the second connecting member 230 extends through and is fixed on the second reinforcing structure 250 and the flexible structure 210.

Further, as shown in FIGS. 6 and 8, the male snap button includes a convex portion 2212, and the female snap button includes a concave portion 2312 connected to the convex portion 2212. The male snap button and the female snap button may be detachably connected to each other through the concave portion 2312 being connected to the convex portion 2212. In other embodiments, the first connecting portion 221 and the second connecting portion 231 may also be of other structures, for example, the first connecting portion 221 may be a first magnetic attraction portion (not shown), and the second connecting portion 231 may be a second magnetic attraction portion (not shown) capable of being magnetically connected to the first magnetic attraction portion, etc., and which are not limited in the present application.

In other embodiments, the second reinforcing structure 250, the second connecting member 230, and the second adhesive medium L2 of the fixing component 200 can also be omitted. The first connecting member 220 may be connected to corresponding connecting structures (not shown) of other external devices. For example, the first connecting member 220 in this embodiment is a male snap button, which may be configured to be connected to the female snap button on the backpack of the caregiver, so that the caregiver can fix the backpack on the baby product to reduce the load on the caregiver.

In this embodiment, the first reinforcing structure 240 is disposed at a position of the flexible structure 210 through which the first spiked portion 2221 extends, and the second reinforcing structure 250 is disposed at a position of the flexible structure 210 through which the second spiked portion 2321 extends. Therefore, when external force is repeatedly applied to disassemble the engagement between the first connecting member 220 and the second connecting member 230, the first reinforcing structure 240 and the second reinforcing structure 250 can respectively hold the first spiked portion 2221 and the second spiked portion 2321, which can prevent the first spiked portion 2221 or the second spiked portion 2321 from pulling the flexible structure 210 and damaging its yarn when the external force is applied. In this way, the first connecting member 220 or the second connecting member 230 may be firmly fixed on the flexible structure 210 and not easy to loosen, thereby improving the durability of the fixing component 200.

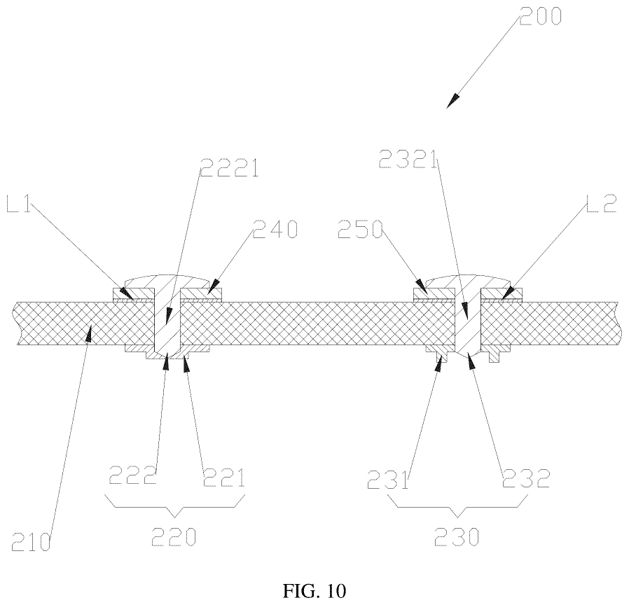

Referring to FIG. 10, in another embodiment, the first connecting member 220 and the second connecting member 230 may be disposed on the same flexible structure 210 at different positions. A distance between the first connecting member 220 and the second connecting member 230 may be set according to actual needs, which is not limited herein. The fixing component 200 according to this embodiment includes the first reinforcing structure 240 and the second reinforcing structure 250 partially covering the flexible structure 210, and the first reinforcing structure 240 and the second reinforcing structure 250 are respectively arranged corresponding to the positions of the first connecting member 220 and the second connecting member 230.

The first reinforcing structure 240 may be bonded to the flexible structure 210 through the first adhesive medium L1, and the second reinforcing structure 250 may be bonded to the flexible structure 210 through the second adhesive medium L2. In addition, in this embodiment, the first connecting portion 221 of the first connecting member 220 and the first reinforcing structure 240 are positioned on opposite sides of the flexible structure 210, respectively. Therefore, the first fixing portion 222 is connected to the first connecting portion 221 by extending through the first reinforcing structure 240 and the flexible structure 210, but is not limited hereto.

In another embodiment, the first connecting portion 221 and the first reinforcing structure 240 may also be positioned on the same side of the flexible structure 210, that is, the first reinforcing structure 240 may be positioned between the first connecting portion 221 and the flexible structure 210. In this case, the first fixing portion 222 first extends through the flexible structure 210, and then extends through the first reinforcing structure 240 to be connected to the first connecting portion 221. As long as the first reinforcing structure 240 can hold the first spiked portion 2221 of the first fixing portion 222, the connection strength between the first connecting member 220 and the flexible structure 210 may be enhanced, and the durability may be improved.

Similarly, the second fixing portion 232 of the second connecting member 230 and the second reinforcing structure 250 are positioned on the same side of the flexible structure 210, and the second fixing portion 232 extends through the second reinforcing structure 250 and the flexible structure 210 to be connected to the second connecting portion 231. In another embodiment, the second connecting portion 231 and the second reinforcing structure 250 may also be positioned on the same side of the flexible structure 210. As long as the second reinforcing structure 250 can hold the second spiked portion 2321 of the second fixing portion 222, the connection strength between the second connecting member 230 and the flexible structure 210 may be enhanced, and the durability may be improved.

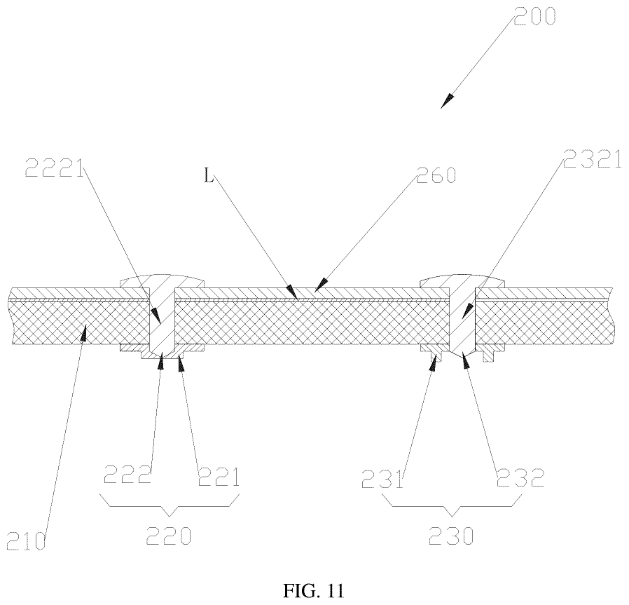

Referring to FIG. 11, a third reinforcing structure 260 of the fixing component 200 in this embodiment has a continuous structure and extends from the first connecting member 220 to the second connecting member 230. In detail, the first fixing portion 222 of the first connecting member 220 and the second fixing portion 232 of the second connecting member 230 extend through the same third reinforcing structure 260 and extend through the flexible structure 210, to be connected to the first connecting portion 221 and the second connecting portion 231, respectively.

In this embodiment, the third reinforcing structure 260 completely covers the flexible structure 210, but is not limited hereto. In another embodiment, as long as the third reinforcing structure 260 covers the predetermined areas of the first connecting member 220 and the second connecting member 230, it can prevent connection failures of the first connecting member 220 and the second connecting member 230 after repeated use, thereby improving durability. In addition, the third reinforcing structure 260 may be made of fabric with low elasticity, and the flexible structure 210 may be made of fabric with high elasticity. In an embodiment, the third reinforcing structure 260 may be made of the same material as the aforementioned first reinforcing structure 240 or the second reinforcing structure 250, and details thereof will not be repeated herein.

In this embodiment, the third reinforcing structure 260 is bonded to the flexible structure 210 through an adhesive medium L. In other words, the adhesive medium L is positioned between the third reinforcing structure 260 and the flexible structure 210. In addition, the third reinforcing structure 260 may be bonded to the flexible structure 210 through hot pressing. The conditions and process of the hot pressing may be referred to above description, and which will not be repeated herein.

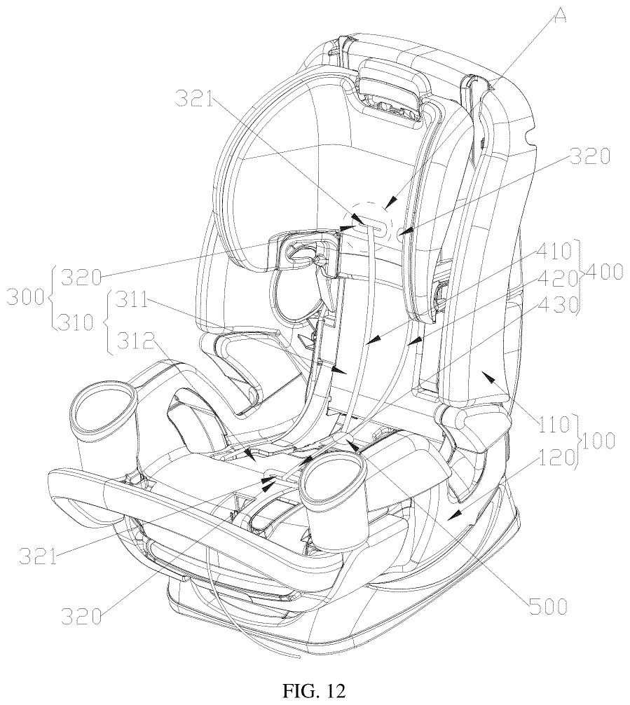

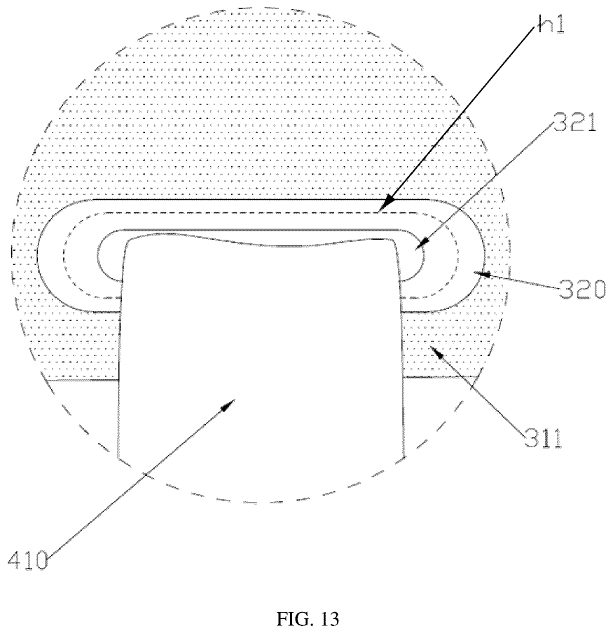

Referring to FIGS. 12 and 13, in yet another embodiment, the baby product may include a structural frame 100. When the baby product is a stroller, the structural frame 100 may be a stroller frame (not shown). When the baby product is a vehicle safety seat, the structural frame 100 may be a backrest 110 or a base 120. The baby product according to this embodiment may further include a mounting component 300 and a belt-shaped structure 400. Firstly, in this embodiment, the vehicle safety seat is used as an example for the baby product, but the mounting assembly 300 can also be applied to other baby products, such as strollers. Therefore, the application field of the mounting component 300 is not limited in present disclosure.

The mounting component 300 includes a flexible structure 310, a reinforcing member 320, and a third adhesive medium (not shown). The flexible structure 310 and the flexible structure 210 in the fixing component 200 may be made of the same fabric or different fabrics. The flexible structure 310 is at least partially fixed to the structural frame 100 of the baby product. In this embodiment, the flexible structure 310 includes a first seat cloth 311 covering the backrest 110 of the vehicle safety seat and a second seat cloth 312 covering the base 120 of the vehicle safety seat.

In an embodiment, the flexible structure 310 may be made of mesh cloth, which has better air permeability, and can improve the seating comfort of babies when used as a seat cloth of a vehicle safety seat or a stroller. In other embodiments, the flexible structure 310 may also be made of other materials such as polyester or knitted cloth. The first seat fabric 311 is provided with two first through holes h1, and the second seat fabric 312 is provided with one first through hole (not shown). The reinforcing member 320 may be made of rubber, fabric or the like. In this embodiment, the reinforcing member 320 is made of thermoplastic polyurethane (TPU). TPU has excellent high tension, high tensile strength, toughness and aging resistance, and is a mature environmental protection material.

In this embodiment, the number of reinforcing members 320 corresponds to the number of the first through holes h1. Accordingly, three reinforcing members 320 are disposed on the flexible structure 310. Each of the reinforcing members 320 includes a second through hole 321 corresponding to the first through hole h1. Each of the reinforcing members 320 is fixed to the corresponding flexible structure 310 via a third adhesive medium, and the second through hole 321 on each of the reinforcing members 320 is at least partially overlapped with the respective first through hole h1. In this embodiment, the second through hole 321 is completely overlapped with the corresponding first through hole h1. In other embodiments, the number and arrangement positions of the first through holes h1 and the second through holes 321 can also be adjusted according to actual needs.

Further, the mounting component 300 can also be manufactured by performing hot pressing on the reinforcing member 320 and the flexible structure 310. In detail, the individual reinforcing member 320 and the flexible structure 310 (including the first seat fabric 311 and the second seat fabric 312) may be more tightly fixed together by using the third adhesive medium under high temperature and high pressure. In an embodiment, the hot pressing may be performed using a thermal transfer device.

One of the reinforcing members 320, one of the third adhesive mediums, and one of the flexible structures 310 are taken as an example to illustrate the specific process of the hot pressing.

The flexible structure 310 is placed on a working platform. Then, the reinforcing member 320 is laid flat on the flexible structure 310. The second through hole 321 of the reinforcing member 320 is disposed corresponding to the first through hole h1 of the flexible structure 310, so that the first through hole h1 and the second through hole 321 are at least partially overlapped with each other. The third adhesive medium is disposed on a surface of the flexible structure 310 facing the reinforcing member 320 or a surface of the reinforcing member 320 facing the flexible structure 310. Then, a thermal transfer device is moved over the reinforcing member 320 to press the reinforcing member 320 and the flexible structure 310 such that the reinforcing member 320 is bonded to the flexible structure 310. In other embodiments, a pressure and a temperature of the hot pressing can also be adjusted as required.

In addition, the belt-shaped structure 400 may be a safety belt on a baby product. In other embodiments, the belt-shaped structure 400 can also be other connection belts on the baby product, adjustment belts for adjusting the inclination of the backrest 110, or the like.

As shown in FIG. 12, the safety belt includes a first safety belt 410, a second safety belt 420, and a third safety belt 430. The first safety belt 410 and the second safety belt 420 respectively extend through two first through holes h1 on the seat cloth of the backrest 110 and two second through holes 321 on the corresponding two reinforcing members 320 from the back of the backrest 110 to the front of the backrest 110 to be connected to a connecting buckle 500. The third safety belt 430 extends through the first through hole on the second seat cloth 312 of the base 120 and the second through hole 321 on the corresponding reinforcing member 320 to the top surface of the base 120 to be connected to the connecting buckle 500. In this way, the first safety belt 410, the second safety belt 420, and the third safety belt 430 can restrain the baby within the vehicle safety seat to ensure the safety of the baby.

Referring to FIG. 13, the first seat cloth 311 or the second seat cloth 312 at the edge of the first through hole h1 may be worn by the first safety belt 410, the second safety belt 420, and the third safety belt 430 during the moving process thereof. In this embodiment, compared with the material used to make the flexible structure 310, the material used to make the reinforcing member 320 is stronger and more wear-resistant. Therefore, arranging corresponding reinforcing members 320 at these positions can reduce wear of the first seat cloth 311 or the second seat cloth 312. In addition, in this embodiment, a diameter of the second through hole 321 is less than a diameter of the first through hole h1. In this way, when the first safety belt 410, the second safety belt 420, and the third safety belt 430 are in use, the first safety belt 410, the second safety belt 420, and the third safety belt 430 are only in contact with the reinforcing members 320, which can prevent the first safety belt 410, the second safety belt 420, and the third safety belt 430 from frequently rubbing against the edges of the first through holes h1.

The reinforcing member 320 may be fixed to the flexible structure 310 by gluing or further hot pressing. Compared with the method of sewing, the gluing or further hot pressing in the present application is firmer, which can greatly save manpower and cost, and will not leave sewing marks or form more holes on the flexible structure 310, and can hardly affect the overall appearance of the baby product. In addition, by arranging the reinforcing member 320, no manual sewing is required on the edges of the first through holes h1 of the flexible structure 310, which can also save time and labor costs.

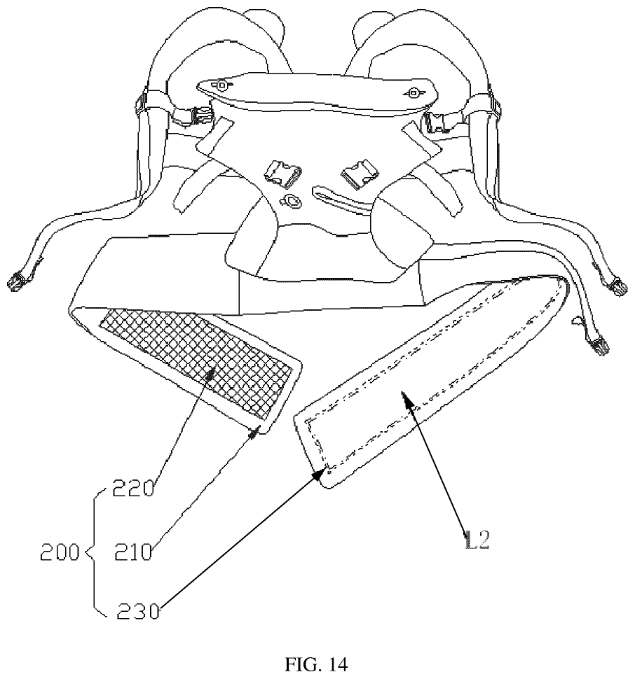

Referring to FIG. 14, the fixing component 200 may be applied to a baby product, which may be a baby sling, but is not limited hereto. The baby product includes a body and the fixing component 200. The fixing component 200 includes the flexible structure 210, the first connecting member 220, the second connecting member 230, the first adhesive medium L1, and the second adhesive medium L2. In this embodiment, the flexible structure 210 is a webbing and is fixed on the body.

The first connecting member 220 and the second connecting member 230 are positioned at two ends of the ribbon, respectively. The first connecting member 220 and the second connecting member 230 are bonded to the flexible structure 210 through the first adhesive medium L1 and the second adhesive medium L2, respectively. In addition, the first connecting member 220 is detachably connected to the second connecting member 230. In another embodiment, any one of the fixing components 200 shown in FIGS. 3 to 5 can also be applied to the baby sling.

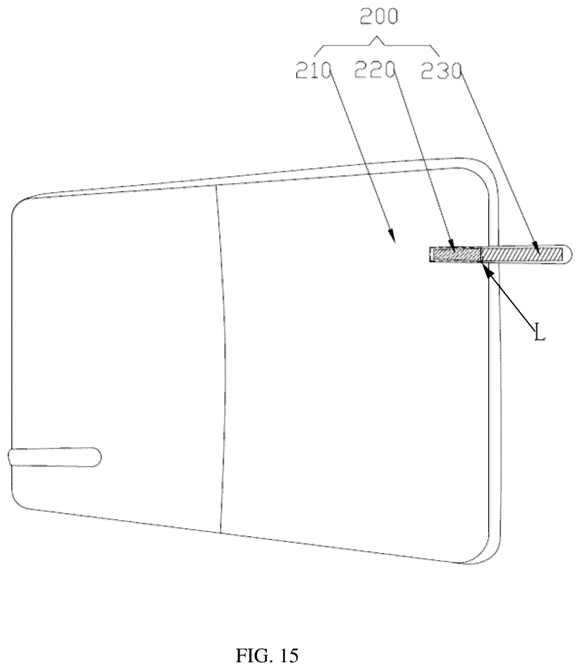

Referring to FIG. 15, in another embodiment, the baby product is a mattress, and the fixing component 200 may be applied on the mattress. In detail, the fixing component 200 includes a flexible structure 210, a first connecting member 220, a second connecting member 230, and an adhesive medium L.

The flexible structure 210 may be a fabric covering an outside of the mattress body, and the first connecting member 220 is bonded to the flexible structure 210 through the adhesive medium L. An end of the first connecting member 220 may be connected to one end of the second connecting member 230. In this embodiment, the other end of the second connecting member 230 is not directly fixed on the flexible structure 210. In this way, when the mattress is in use, the other end of the second connecting member 230 may be wound around a railing or other rod-shaped fixtures on a crib, and then connected to the first connecting member 220, so that the mattress may be fixed. In another embodiment, any one of the fixing components 200 shown in FIGS. 10 and 11 can also be applied to the mattress.

The above-mentioned fixing component 200, mounting component 300, and baby products have at least the following technical effects.

The connecting member (or reinforcing member 320) is fixed on the flexible structure 210 (or flexible structure 310) through the adhesive medium, so that the connecting member (or reinforcing member 320) is firmly bonded to the flexible structure 210 (or flexible structure 310), and it is difficult to cause the connection failure. In addition, compared with the conventional sewing fixing manners, the fixing through the adhesive medium can greatly save manpower and cost, and will not leave sewing marks or form more holes on the flexible structure 210 (or flexible structure 310), and can hardly affect the overall appearance of the baby product.

The technical features of the above-described embodiments may be combined arbitrarily. To simplify the description, not all possible combinations of the technical features in the above embodiments are described. However, all of the combinations of these technical features should be considered as being fallen within the scope of the present application, as long as such combinations do not contradict with each other.

The foregoing embodiments merely illustrate some embodiments of the present application, and descriptions thereof are relatively specific and detailed. However, it should not be understood as a limitation to the patent scope of the present application. It should be noted that, a person of ordinary skill in the art may further make some variants and improvements without departing from the concept of the present application, and the variants and improvements falls within the protection scope of the present application. Therefore, the protection scope of the present application shall be subject to the appended claims.

1. A fixing component suitable for being applied to a baby product, comprising:
a connecting member,
a flexible structure, and
an adhesive medium provided between the connecting member and the flexible structure;
wherein the connecting member is fixed to the flexible structure via the adhesive medium.

2. The fixing component according to claim 1, wherein the connecting member is fixed to the flexible structure by hot pressing.

3. The fixing component according to claim 1, wherein the adhesive medium is a polyurethane adhesive.

4. The fixing component according to claim 1, wherein the connecting member is a hook surface or a loop surface of a hook and loop fastener.

5. (canceled)

6. The fixing component according to claim 1, wherein the flexible structure is made of polyester or knitted fabric.

7. The fixing component according to claim 1, further comprising a reinforcing structure;
wherein the reinforcing structure is fixed to the flexible structure via the adhesive medium, and is positioned between the connecting member and the flexible structure; and the connecting member extends through and is fixed to the reinforcing structure and the flexible structure.

8. A baby product, comprising:
a body, and
a fixing component comprising:
a first connecting member,
a flexible structure at least partially provided on the body, and
a first adhesive medium provided between the first connecting member and the flexible structure; wherein the first connecting member is fixed to the flexible structure via the first adhesive medium.

9. The baby product according to claim 8, wherein the first connecting member is fixed to the flexible structure by hot pressing.

10. The baby product according to claim 8, wherein the fixing component further comprises a second connecting member having an end connected to the first connecting member.

11. The baby product according to claim 8, wherein the fixing component further comprises a second connecting member and a second adhesive medium; and the second connecting member is fixed to the flexible structure via the second adhesive medium.

12. The baby product according to claim 10, wherein the first connecting member is a hook surface of a hook and loop fastener, and the second connecting member is a loop surface of the hook and loop fastener.

13. A fixing component suitable for being applied to a baby product, comprising:
a connecting member,
a reinforcing structure,
a flexible structure, and
an adhesive medium provided between the reinforcing structure and the flexible structure, wherein the reinforcing structure is fixed to the flexible structure via the adhesive medium, the reinforcing structure covers at least a part of a surface of the flexible structure, and the connecting member extends through and is fixed to the reinforcing structure and the flexible structure.

14. The fixing component according to claim 13, wherein the reinforcing structure is fixed to the flexible structure via the adhesive medium through hot pressing.

15. The fixing component according to claim 13, wherein the adhesive medium is a polyurethane adhesive.

16. The fixing component according to claim 13, wherein the connecting member comprises a connecting portion and a fixing portion, the connecting portion and the fixing portion being respectively positioned on both sides of the flexible structure,
wherein the fixing portion is configured to extend through the reinforcing structure and the flexible structure to be connected to the connecting portion; or
wherein the connecting portion is configured to extend through the reinforcing structure and the flexible structure to be connected to the fixing portion.

17. The fixing component according to claim 16, wherein the fixing portion comprises a spiked portion, the connecting portion is provided with a matching hole, and the spiked portion extends through the reinforcing structure and the flexible structure to be detachably engaged with the matching hole.

18. The fixing component according to claim 16, wherein the connecting portion is a male snap button or a female snap button.

19. The fixing component according to claim 13, wherein the reinforcing structure and the flexible structure are both made of fabric, and an elasticity of the reinforcing structure is lower than an elasticity of the flexible structure.

20. The fixing component according to claim 13, wherein the reinforcing structure is made of polyester, and the flexible structure is made of elastic knitted fabric.

21. The fixing component according to claim 13, wherein a cushioning structure is provided between the reinforcing structure and the flexible structure.

22-32. (canceled)
